(19) United States
(12) Patent Application Publication
(10) Pub. No.: US 2015/0365033 A1
(43) Pub. Date: Dec. 17, 2015

(54) GRID-CONNECTED INDUCTION MACHINE WITH CONTROLLABLE POWER FACTOR

(71) Applicant: THE GOVERNORS OF THE UNIVERSITY OF ALBERTA, Edmonton (CA)

(72) Inventors: John Salmon, Edmonton (CA); Andrew Knight, Edmonton (CA)

(73) Assignee: THE GOVERNORS OF THE UNIVERSITY OF ALBERTA, Edmonton, AB (CA)

(21) Appl. No.: 14/798,245

(22) PCT Filed: Jan. 14, 2014
(86) PCT No.: PCT/CA2014/000019

§ 371 Date: Jul. 13, 2015

Related U.S. Application Data
(60) Provisional application No. 61/752,189, filed on Jan. 14, 2013.

(51) Int. Cl. H02P 23/00; H02P 23/06; H02P 9/00; H02P 4/00

(52) U.S. Cl. CPC H02P 23/0081; H02P 4/00; H02P 23/065; H02P 9/00

(57) ABSTRACT

A method and system for controlling the power factor of induction machines connected to power distribution grids are provided. In some embodiments, the method can comprise inserting an adjustable voltage source in series with one or more windings of a grid-connected induction machine such that the adjustable voltage source can be adjusted to manipulate the phase angle of the current flowing through the one or more windings relative to the phase angle of the grid voltage. The system can comprise an adjustable voltage source in series with one or more windings of a grid-connected induction machine such that the adjustable voltage source can be adjusted to manipulate the phase angle of the current flowing through the one or more windings relative to the phase angle of the grid voltage.

### RELATED APPLICATIONS

This application claims the benefit of U.S. Provisional Patent Application No. 61/752,189 filed Jan. 14, 2013, which is hereby incorporated by reference.

### FIELD OF THE INVENTION

The present disclosure is related to the field of electric power distribution, and in particular, to techniques for controlling the power factor of an induction machine that is connected to an electric power distribution grid.

### BACKGROUND

Power factor is the ratio between real power and reactive power in a power system. In a power system with a sinusoidal alternating voltage supply, power factor can be calculated by taking the cosine of the difference in phase angles between voltage and current waveforms. Therefore, the power factor of a power system will be one (or unity) when the voltage and current waveforms are in phase, and zero when the phase of the current waveform differs from that of the voltage waveform by 90 degrees. When the difference between the phases of the voltage waveform and the current waveform is greater than zero, the power factor is said to be lagging and when the difference between the phases of the voltage waveform and the current waveform is less than zero, the power factor is said to be leading.

Power factor plays a significant role in the efficiency of a power system. Reactive power does no useful work, but requires current to flow in the power system to supply it. Thus, power factor can be viewed as a measure of the ratio of useful current to total current flowing in a power system. The closer the power factor of a power system is to unity, the more efficient the power system will be. For example, improving the power factor of a power system from 0.9 to 1.0 will result in 19% fewer losses in the power system for the same real power flow, or, viewed another way, will allow the useful power capacity of the power system to be increased by 11%.

Induction machines are the primary reason why significant amounts of reactive power are needed in many power systems. The inability to control the reactive power demands that induction machines place on power systems is a problem that has existed since their invention in the late 19^{th} century. With wind generation becoming more prevalent and many wind turbines employing induction generators, the problem has only increased in significance.

Existing solutions for controlling the reactive power demands of induction machines on power distribution grids include the use of capacitor banks, static VAR compensators and superconducting magnetic energy storage devices. These systems are expensive and prone to relatively high rates of failure.

It is therefore desirable to provide a system and method for controlling the power factor of induction machines connected to power distribution grids.

### SUMMARY

A method for controlling the power factor of an induction machine connected to a power distribution grid is provided. The grid can include an alternating voltage supply and at least one distribution line, and the induction machine can include at least one winding.

Broadly stated, in some embodiments, the method includes the steps of: connecting the at least one winding to the at least one distribution line such that the alternating voltage supply can deliver current to the at least one winding; connecting an adjustable voltage source in series with the at least one winding, the adjustable voltage source configured to produce an output voltage whose magnitude and phase angle can be adjusted; and adjusting the magnitude and phase angle of the output voltage until the desired power factor is achieved.

In some embodiments, the adjustable voltage source can include an alternating current to direct current power electronic converter and a direct current energy storage device.

In some embodiments, the alternating current to direct current power electronic converter includes a floating H-bridge.

In some embodiments, the direct current energy storage device includes a capacitor, a super capacitor or an electro-chemical battery.

In some embodiments, the induction machine includes an induction motor or an induction generator.

A method for controlling the power factor of a polyphase induction machine connected to a polyphase power distribution grid is provided. The grid can include a plurality of grid phases, and each grid phase can further include an alternating voltage supply and at least one distribution line. The induction machine can include a plurality of induction machine phases, and each induction machine phase can further include at least one winding.

Broadly stated, in some embodiments, the method can include the steps of: connecting the at least one winding of a first induction machine phase to the at least one distribution line of a first grid phase such that the alternating voltage supply of the first grid phase can deliver current to the at least one winding of the first induction machine phase; connecting the at least one winding of the first induction machine phase to one or more other at least one windings of one or more other induction machine phases as required to achieve the desired connection configuration between the polyphase power distribution grid and the polyphase induction machine; connecting an adjustable voltage source in series with the at least one winding of the first induction machine phase, the adjustable voltage source configured to produce an output voltage whose magnitude and phase angle can be adjusted; and adjusting the magnitude and phase angle of the output voltage until the desired power factor is achieved.

In some embodiments, the adjustable voltage source can include an alternating current to direct current power electronic converter and a direct current energy storage device.

In some embodiments, the alternating current to direct current power electronic converter includes a floating H-bridge.

In some embodiments, the polyphase power distribution grid includes a three-phase power distribution grid and the induction machine includes a three-phase induction machine.

In some embodiments, the desired connection configuration between the three-phase power distribution grid and the three-phase induction machine includes a wye or delta configuration.

In some embodiments, the adjustable voltage source can include a three-phase adjustable voltage source disposed to produce three output voltages whose magnitudes and phase angles can be adjusted, and the three-phase adjustable voltage source can be connected in series with two or more at least one windings of one or more induction machine phases such that adjusting the magnitudes and phase angles of the output voltages can cause changes in the phase angles of the currents flowing through the two or more at least one windings, and the magnitudes and phase angles of the output voltages can be adjusted until the phase angles of the currents flowing through the two or more at least one windings are such that the desired power factor is achieved.

In some embodiments, the three-phase adjustable voltage source includes an alternating current to direct current power electronic converter and a direct current energy storage device.

In some embodiments, the alternating current to direct current power electronic converter includes a floating three-phase inverter.

In some embodiments, the direct current energy storage device includes a capacitor, a super capacitor or an electro-chemical battery.

In some embodiments, the induction machine includes an induction motor or an induction generator.

Broadly stated, in some embodiments, an improved induction machine with a controllable power factor is provided, the improved induction machine including: at least one induction machine phase, each induction machine phase further including at least one winding; means for connecting the at least one winding of each induction machine phase to an external alternating voltage supply such that current can be supplied to the at least one winding of each at least one induction machine phase; at least one adjustable voltage source configured to produce at least one output voltage whose magnitude and phase angle can be adjusted; and means for connecting the at least one adjustable voltage source in series with the at least one winding of the at least one induction machine phase, wherein adjusting the magnitude and phase angle of the at least one output voltage changes the power factor.

In some embodiments, the improved induction machine can further include means for connecting the at least one winding of each at least one induction machine phase to one or more other at least one windings of one or more other induction machine phases as required to achieve the desired connection configuration between the induction machine phases.

In some embodiments, the adjustable voltage source can include an alternating current to direct current power electronic converter and a direct current energy storage device.

In some embodiments, the alternating current to direct current power electronic converter can include a floating H-bridge.

In some embodiments, the number of induction machine phases can be three.

In some embodiments, the desired connection configuration between the induction machine phases can include a wye or delta configuration.

In some embodiments, the adjustable voltage source can include a three-phase adjustable voltage source disposed to produce three output voltages whose magnitudes and phase angles can be adjusted, and the three-phase adjustable voltage source can be connected in series with two or more at least one windings of one or more induction machine phases such that adjusting the magnitudes and phase angles of the output voltages can cause changes in the phase angles of the currents flowing through the two or more at least one windings.

In some embodiments, the three-phase adjustable voltage source can include an alternating current to direct current power electronic converter and a direct current energy storage device.

In some embodiments, the alternating current to direct current power electronic converter can include a floating three-phase inverter.

In some embodiments, the direct current energy storage device can include a capacitor, a super capacitor or an electro-chemical battery.

In some embodiments, the improved induction machine can include an improved induction motor or an improved induction generator.

### BRIEF DESCRIPTION OF THE DRAWINGS:

FIG. 1A is a schematic diagram depicting an embodiment of a grid-connected induction machine with a controllable power factor.

FIG. 1B is a phasor diagram depicting the difference in phase angles between the voltage and current flowing through the induction machine winding depicted in FIG. 1A.

FIG. 1C is a phasor diagram depicting how a voltage can be applied by the adjustable voltage source in FIG. 1A to match the phase angle of the winding current to the phase angle of the grid AC source voltage.

FIG. 1D is a phasor diagram depicting how a voltage can be applied by the adjustable voltage source in FIG. 1A to create a leading phase angle between the grid AC source voltage and the winding current.

FIG. 2 is a schematic diagram depicting one embodiment of a floating H-bridge with an integral DC capacitor.

FIG. 3 is a schematic diagram depicting an embodiment of a grid-connected split-phase induction machine with a controllable power factor.

FIG. 4 is a schematic diagram depicting an embodiment of a wye-equivalent three-phase grid-connected induction machine with a controllable power factor.

FIG. 5 is a schematic diagram depicting an embodiment of a delta-equivalent three-phase grid-connected induction machine with a controllable power factor.

FIG. 6 is a schematic diagram depicting an embodiment of a floating three-phase inverter with an integral DC capacitor.

FIG. 7A is a schematic diagram depicting an embodiment of a three-phase grid-connected induction machine connected in an open winding configuration.

FIG. 7B is a schematic diagram depicting an embodiment of a three-phase grid-connected induction machine connected in a wye configuration.

FIG. 7C is a schematic diagram depicting an embodiment of a three-phase grid-connected induction machine connected in a delta configuration.

FIG. 8A is a schematic diagram depicting an embodiment of a nine-terminal three-phase grid-connected induction machine connected in a wye configuration.

FIG. 8B is a schematic diagram depicting an embodiment of a nine-terminal three-phase grid-connected induction machine connected in a wye configuration with the windings connected to operate at a high voltage.

FIG. 8C is a schematic diagram depicting an embodiment of a nine-terminal three-phase grid-connected induction machine connected in a wye configuration with the windings connected to operate at a low voltage.

FIG. 9A is a schematic diagram depicting an embodiment of a nine-terminal three-phase grid-connected induction machine connected in a delta configuration.

FIG. 9B is a schematic diagram depicting an embodiment of a nine-terminal three-phase grid-connected induction machine connected in a delta configuration with the windings connected to operate at a high voltage.

FIG. 9C is a schematic diagram depicting an embodiment of a nine-terminal three-phase grid-connected induction machine connected in a delta configuration with the windings connected to operate at a low voltage.

FIG. 10A is a schematic diagram depicting an embodiment of a three-phase grid-connected induction machine connected in an open winding configuration with the floating three-phase inverter of FIG. 6 such that the power factor of the induction machine can be controlled by the floating three-phase inverter.

FIG. 10B is a schematic diagram depicting another embodiment of a three-phase grid-connected induction machine connected in an open winding configuration with two of the floating H-bridges of FIG. 2 such that the power factor of the induction machine can be controlled by the floating H-bridges.

FIG. 10C is a schematic diagram depicting another embodiment of a three-phase grid-connected induction machine connected in an open winding configuration with three of the floating H-bridges of FIG. 2 such that the power factor of the induction machine can be controlled by the floating H-bridges.

FIG. 11A is a schematic diagram depicting one embodiment of a three-phase grid-connected induction machine connected in a wye configuration with two of the floating H-bridges of FIG. 2 such that the power factor of the induction machine can be controlled by the floating H-bridges.

FIG. 11B is a schematic diagram depicting another embodiment of a three-phase grid-connected induction machine connected in a wye configuration with three of the floating H-bridges of FIG. 2 such that the power factor of the induction machine can be controlled by the floating H-bridges.

FIG. 12A is a schematic diagram depicting one embodiment of a three-phase grid-connected induction machine connected in a delta configuration with three of the floating H-bridges of FIG. 2 such that the power factor of the induction machine can be controlled by the floating H-bridges.

FIG. 12B is a schematic diagram depicting another embodiment of a three-phase grid-connected induction machine connected in a delta configuration with two of the floating H-bridges of FIG. 2 such that the power factor of the induction machine can be controlled by the floating H-bridges.

FIG. 12C is a schematic diagram depicting another embodiment of a three-phase grid-connected induction machine connected in a delta configuration with three of the floating H-bridges of FIG. 2 such that the power factor of the induction machine can be controlled by the floating H-bridges.

FIG. 13A is a schematic diagram depicting one embodiment of a nine-terminal three-phase grid-connected induction machine connected in a wye configuration with the windings connected to operate at a high voltage connected with three of the floating H-bridges of FIG. 2 such that the power factor of the induction machine can be controlled by the floating H-bridges.

FIG. 13B is a schematic diagram depicting another embodiment of a nine-terminal three-phase grid-connected induction machine connected in a wye configuration with the windings connected to operate at a high voltage connected with three of the floating H-bridges of FIG. 2 such that the power factor of the induction machine can be controlled by the floating H-bridges.

FIG. 13C is a schematic diagram depicting one embodiment of a nine-terminal three-phase grid-connected induction machine connected in a wye configuration with the windings connected to operate at a low voltage connected with three of the floating H-bridges of FIG. 2 such that the power factor of the induction machine can be controlled by the floating H-bridges.

FIG. 13D is a schematic diagram depicting one embodiment of a nine-terminal three-phase grid-connected induction machine connected in a wye configuration with the windings connected to operate at a low voltage connected with three of the floating three-phase inverters of FIG. 6 such that the power factor of the induction machine can be controlled by the floating three-phase inverters.

FIG. 14A is a schematic diagram depicting one embodiment of a nine-terminal three-phase grid-connected induction machine connected in a delta configuration with the windings connected to operate at a high voltage connected with three of the floating H-bridges of FIG. 2 such that the power factor of the induction machine can be controlled by the floating H-bridges.

FIG. 14B is a schematic diagram depicting another embodiment of a nine-terminal three-phase grid-connected induction machine connected in a delta configuration with the windings connected to operate at a high voltage connected with three of the floating H-bridges of FIG. 2 such that the power factor of the induction machine can be controlled by the floating H-bridges.

FIG. 14C is a schematic diagram depicting another embodiment of a nine-terminal three-phase grid-connected induction machine connected in a delta configuration with the windings connected to operate at a high voltage connected with three of the floating three-phase inverters of FIG. 6 such that the power factor of the induction machine can be controlled by the floating three-phase inverters.

FIG. 14D is a schematic diagram depicting one embodiment of a nine-terminal three-phase grid-connected induction machine connected in a delta configuration with the windings connected to operate at a low voltage connected with three of the floating H-bridges of FIG. 2 such that the power factor of the induction machine can be controlled by the floating H-bridges.

FIG. 14E is a schematic diagram depicting another embodiment of a nine-terminal three-phase grid-connected induction machine connected in a delta configuration with the windings connected to operate at a low voltage connected with three of the floating H-bridges of FIG. 2 such that the power factor of the induction machine can be controlled by the floating H-bridges.

FIG. 14F is a schematic diagram depicting another embodiment of a nine-terminal three-phase grid-connected induction machine connected in a delta configuration with the windings connected to operate at a low voltage connected with three of the floating three-phase inverters of FIG. 6 such that the power factor of the induction machine can be controlled by the floating three-phase inverters.

FIG. 15 is a block diagram depicting one embodiment of a control system for the three-phase inverter of FIG. 6.

### DETAILED DESCRIPTION OF EMBODIMENTS

A method for controlling the power factor of an induction machine connected to a power distribution grid according to the invention is provided. The power distribution grid has an alternating voltage supply and a distribution line, and the induction machine has at least one winding, as described below. The winding is connected to the distribution line allowing the alternating voltage supply to deliver current to the winding. The adjustable voltage source is connected, and may be connected in series, to the winding, and the magnitude and phase angle of the adjustable voltage source is adjustable. The adjustable voltage source may be an alternating current to direct current power electronic converter and a direct current energy storage device, such as a capacitor, a super capacitor or an electro-chemical battery. The induction machine may be an induction motor or an induction generator. The converter may be controlled using closed-loop feedback, open-loop control, or operate under a pre-defined condition.

A method further provides for controlling the power factor of a polyphase induction machine (for example, three phases) connected to a polyphase power distribution grid having a plurality of grid phases (for example, three phases), each grid phase further having an alternating voltage supply and at least one distribution line. The induction machine has a plurality of induction machine phases, and each induction machine phase has at least one winding. The winding of the first induction machine phase is connected to the distribution line such that the alternating voltage supply of the first grid phase can deliver current to the winding. The winding of the first induction machine phase is also connected to one or more other windings the other induction machine phases as required to achieve the desired connection configuration between the polyphase power distribution grid and the polyphase induction machine. An adjustable voltage source is connected in series with the winding of the first induction machine phase, and the adjustable voltage source is configured to produce an output voltage whose magnitude and phase angle can be adjusted to achieve the desired power factor.

The invention also provides an induction machine with a controllable power factor, the improved induction machine having one or more induction machine phases, each induction machine phase having one or more windings. A winding of each induction machine phase is connected to an external alternating voltage supply such that current can be supplied to the winding of each induction machine phase. An adjustable voltage source is configured to produce at least one output voltage whose magnitude and phase angle can be adjusted; and the adjustable voltage source is connected in series with at least one winding of the an induction machine phase, wherein adjusting the magnitude and phase angle of the output voltage changes the power factor.

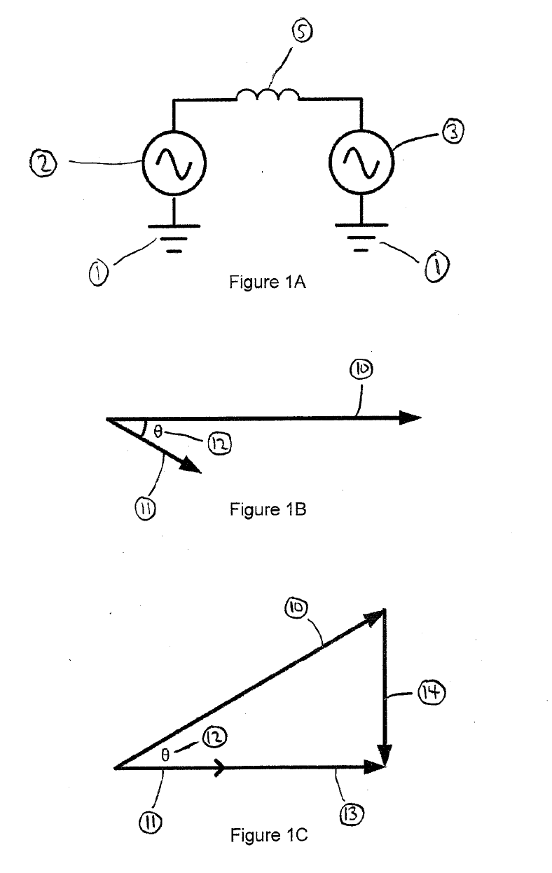

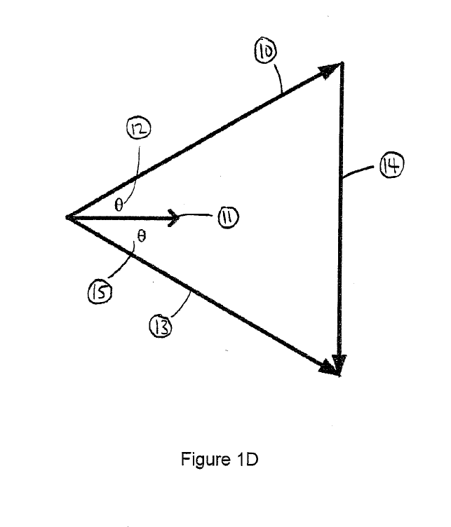

Now examples of the invention are described in reference to the figures. Referring to FIG. 1A, one embodiment of a grid-connected induction machine with a controllable power factor is shown. In this embodiment, induction machine winding 5 is placed in series with grid AC source 2 and adjustable voltage source 3, and grid AC source 2 and adjustable voltage source 3 are both connected to ground 1. In this configuration, the sum of the voltages across induction machine winding 5 and adjustable voltage source 3 must equal the voltage of grid AC source 2.

Referring to FIGS. 1B and 1C, in operation, the voltage and current flowing through induction machine winding 5 can be represented by winding voltage phasor 10 and winding current phasor 11, respectively. The voltage of grid AC source 2 can be represented by grid AC source voltage phasor 13 and the voltage of adjustable voltage source 3 can be represented by adjustable voltage source phasor 14. The difference in phase angles between the voltage and current flowing through induction machine winding 5 can be represented by winding phase angle difference 12.

Referring to FIG. 1C, in operation, the output of adjustable voltage source 3 is adjusted until the phase angle of the current flowing through induction machine winding 5 matches the phase angle of the voltage of grid AC source 2.

Referring to FIG. 1 D, in operation, the output of adjustable voltage source 3 can be further adjusted until the phase angle of the current flowing through the induction machine leads the phase angle of the voltage of grid AC source 2, producing grid phase angle difference 15. As shown in FIG. 1D, grid phase angle difference 15 can be equal and opposite to winding phase angle difference 12.

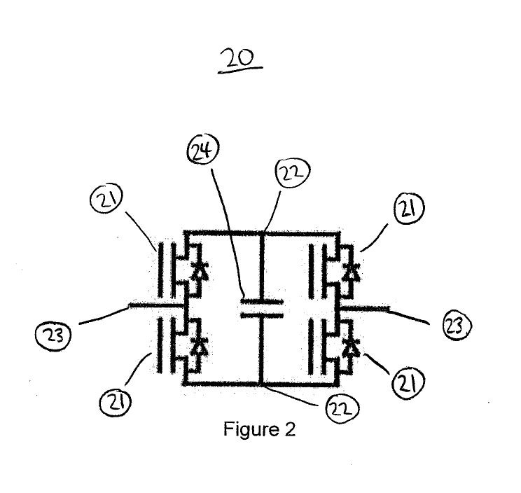

Referring to FIG. 2, one embodiment of an adjustable voltage source is shown in the form of floating H-bridge 20. In this embodiment, floating H-bridge 20 includes transistors 21, DC connections 22, AC connection points 23 and integral DC capacitor 24. In some embodiments, floating H-bridge 20 can be controlled to produce the required output voltage using pulse width modulated switching signals from a digital controller. The digital controller can receive inputs from sensors that measure the voltage supplied by the power grid and the current flowing through the induction motor winding and adjust the pulse width modulated switching signals controlling floating H-bridge 20 to produce the required output voltage for the desired power factor. The digital controller can also receive feedback in the form of the voltage signal across integral DC capacitor 24 of floating H-bridge 20.

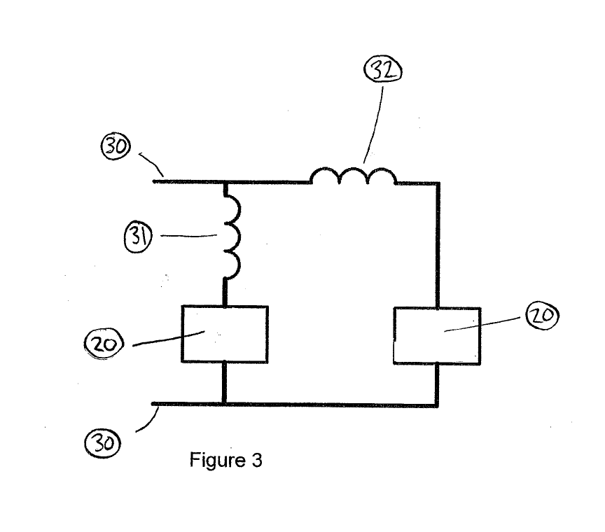

Referring to FIG. 3, one embodiment of a grid-connected split-phase induction machine with a controllable power factor is shown. In this embodiment, floating H-bridges 20 are placed in series with main winding 31 and auxiliary winding 32. Alternating current is supplied to the system via single phase supply lines 30.

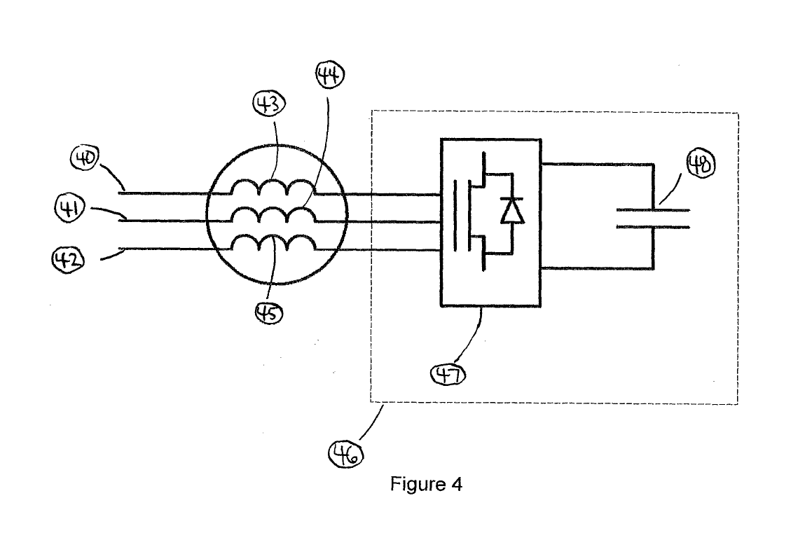

Referring to FIG. 4, one embodiment of a wye-equivalent three-phase grid-connected induction machine with a controllable power factor is shown. In this embodiment, first phase winding 43, second phase winding 44 and third phase winding 45 receive alternating current from first phase supply line 40, second phase supply line 41 and third phase supply line 42, respectively. First phase winding 43, second phase winding 44 and third phase winding 45 are also connected to three-phase adjustable voltage source 46. Three-phase adjustable voltage source 46 may include three-phase alternating current to direct current power electronic converter 47 and DC capacitor 48.

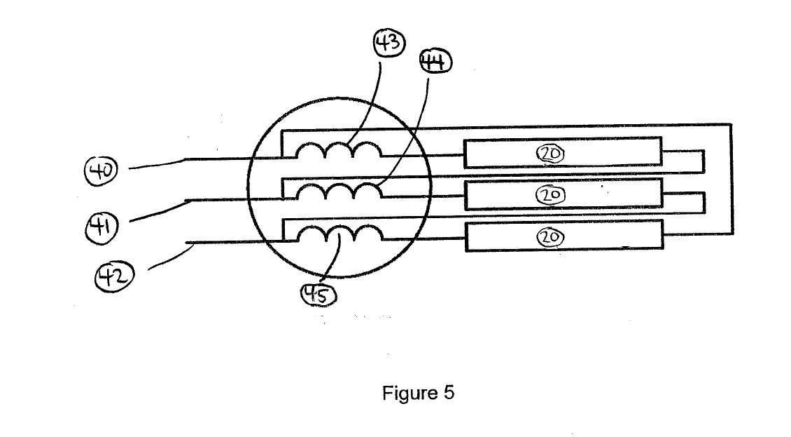

Referring to FIG. 5, one embodiment of a delta-equivalent three-phase grid-connected induction machine with a controllable power factor is shown. In this embodiment, first phase winding 43, second phase winding 44 and third phase winding 45 receive alternating current from first phase supply line 40, second phase supply line 41 and third phase supply line 42, respectively. First phase winding 43, second phase winding 44 and third phase winding 45 are also connected to floating H-bridges 20 as shown.

Referring to FIG. 6, one embodiment of a floating three-phase inverter with an integral DC capacitor is shown. In this embodiment, floating three-phase inverter 60 can comprise transistors 61, DC connections 62, AC connection points 63 and integral DC capacitor 64.

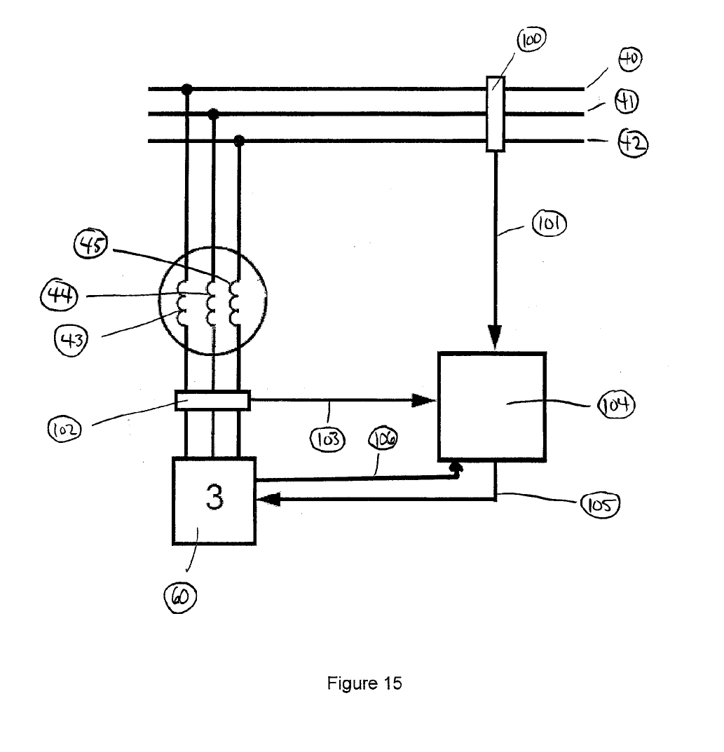

Referring to FIG. 15, one embodiment of a control system for floating three-phase inverter 60 is shown. Supply line voltage sensors 100 detect voltages of first phase supply line 40, second phase supply line 41 and third phase supply line 42 and transmit supply line voltage signals 101 to digital controller 104. Induction machine winding current sensors 102 detect currents flowing through first phase winding 43, second phase winding 44 and third phase winding 45 and transmit induction machine current signals 103 to digital controller 104. The output voltages of floating three-phase inverter 60 are controlled by digital controller 104 via pulse width modulated switching signals 105. Digital controller 104 receives feedback from floating three-phase inverter 60 in the form of DC capacitor feedback signal 106, which represents the voltage across integral DC capacitor 64 of floating three-phase inverter 60.

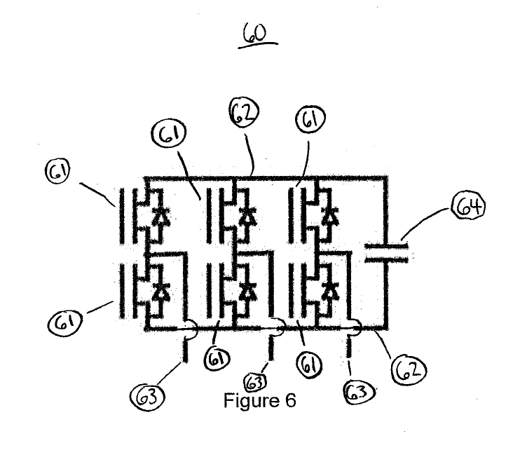

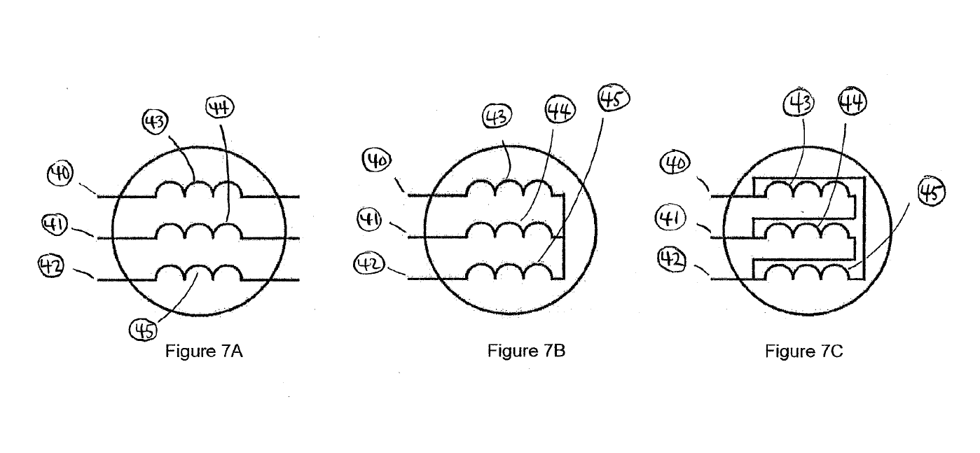

Referring to FIG. 7A, one embodiment of a three-phase grid-connected induction machine connected in an open winding configuration is shown. In this embodiment, first phase winding 43, second phase winding 44 and third phase winding 45 receive alternating current from first phase supply line 40, second phase supply line 41 and third phase supply line 42, respectively.

Referring to FIG. 7B, one embodiment of a three-phase grid-connected induction machine connected in a wye configuration is shown. In this embodiment, first phase winding 43, second phase winding 44 and third phase winding 45 receive alternating current from first phase supply line 40, second phase supply line 41 and third phase supply line 42, respectively. First phase winding 43, second phase winding 44 and third phase winding 45 can be connected as shown in FIG. 7B to achieve the wye connection configuration.

Referring to FIG. 7C, one embodiment of a three-phase grid-connected induction machine connected in a delta configuration is shown. In this embodiment, first phase winding 43, second phase winding 44 and third phase winding 45 receive alternating current from first phase supply line 40, second phase supply line 41 and third phase supply line 42, respectively. First phase winding 43, second phase winding 44 and third phase winding 45 can be connected as shown in FIG. 7C to achieve the delta connection configuration.

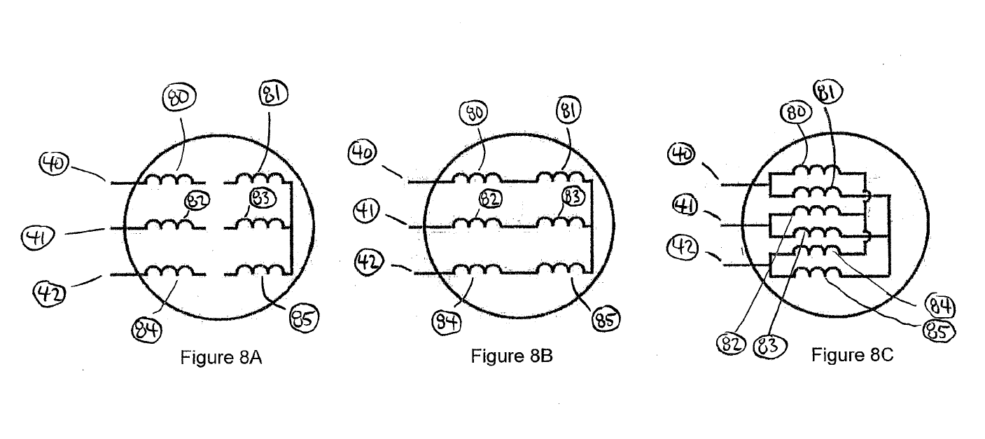

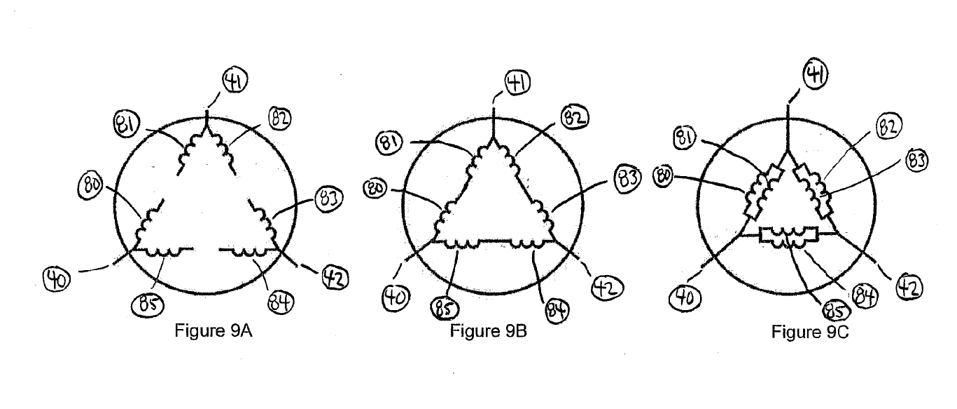

Referring to FIG. 8A, one embodiment of a nine-terminal three-phase grid-connected induction machine connected in a wye configuration is shown. In this embodiment, first phase winding 1 80, second phase winding 1 82 and third phase winding 1 84 receive alternating current from first phase supply line 40, second phase supply line 41 and third phase supply line 42, respectively. The connections between first phase winding 1 80, second phase winding 1 82 and third phase winding 1 84 and first phase winding 2 81, second phase winding 2 83 and third phase winding 2 85, respectively, are left open. First phase winding 2 81, second phase winding 2 83 and third phase winding 2 85 are connected together as shown in FIG. 8A.

Referring to FIG. 8B, one embodiment of a nine-terminal three-phase grid-connected induction machine connected in a wye configuration with the windings connected to operate at a high voltage is shown. In this embodiment, first phase winding 1 80, second phase winding 1 82 and third phase winding 1 84 receive alternating current from first phase supply line 40, second phase supply line 41 and third phase supply line 42, respectively. First phase winding 1 80, second phase winding 1 82 and third phase winding 1 84 are connected in series with first phase winding 2 81, second phase winding 2 83 and third phase winding 2 85, respectively and first phase winding 2 81, second phase winding 2 83 and third phase winding 2 85 are connected together as shown in FIG. 8B in order to achieve the high voltage, wye connection configuration.

Referring to FIG. 8C, one embodiment of a nine-terminal three-phase grid-connected induction machine connected in a wye configuration with the windings connected to operate at a low voltage is shown. In this embodiment, first phase winding 1 80, second phase winding 1 82 and third phase winding 1 84 receive alternating current from first phase supply line 40, second phase supply line 41 and third phase supply line 42, respectively. First phase winding 1 80, second phase winding 1 82 and third phase winding 1 84 are connected in parallel with first phase winding 2 81, second phase winding 2 83 and third phase winding 2 85, respectively and first phase winding 1 80, second phase winding 1 82 and third phase winding 1 84 and first phase winding 2 81, second phase winding 2 83 and third phase winding 2 85 are connected together as shown in FIG. 8C in order to achieve the low voltage, wye connection configuration.

Referring to FIG. 9A, one embodiment of a nine-terminal three-phase grid-connected induction machine connected in a delta configuration is shown. In this embodiment, first phase winding 1 80, second phase winding 1 82 and third phase winding 1 84 receive alternating current from first phase supply line 40, second phase supply line 41 and third phase supply line 42, respectively. The connections between first phase winding 1 80, second phase winding 1 82 and third phase winding 1 84 and first phase winding 2 81, second phase winding 2 83 and third phase winding 2 85, respectively, are left open. First phase winding 1 80 is connected to third phase winding 2 85, first phase winding 2 81 is connected to second phase winding 1 82, and second phase winding 2 83 is connected to third phase winding 1 84 as shown in FIG. 9A.

Referring to FIG. 9B, one embodiment of a nine-terminal three-phase grid-connected induction machine connected in a delta configuration with the windings connected to operate at a high voltage is shown. In this embodiment, first phase winding 1 80, second phase winding 1 82 and third phase winding 1 84 receive alternating current from first phase supply line 40, second phase supply line 41 and third phase supply line 42, respectively. First phase winding 1 80, second phase winding 1 82 and third phase winding 1 84 are connected in series with first phase winding 2 81, second phase winding 2 83 and third phase winding 2 85, respectively. First phase winding 1 80 is connected to third phase winding 2 85, first phase winding 2 81 is connected to second phase winding 1 82, and second phase winding 2 83 is connected to third phase winding 1 84 as shown in FIG. 9B in order to achieve the high voltage, delta connection configuration.

Referring to FIG. 9C, one embodiment of a nine-terminal three-phase grid-connected induction machine connected in a delta configuration with the windings connected to operate at a low voltage is shown. In this embodiment, first phase supply line 40, second phase supply line 41 and third phase supply line 42 supply alternating current to the induction machine. First phase winding 1 80 and first phase winding 2 81 are connected in parallel between first phase supply line 40 and second phase supply line 41, second phase winding 1 82 and second phase winding 2 83 are connected in parallel between second phase supply line 41 and third phase supply line 42 and third phase winding 1 84 and third phase winding 2 85 are connected in parallel between third phase supply line 42 and first phase supply line 40 as shown in FIG. 9C in order to achieve the low voltage, delta connection configuration.

Referring to FIGS. 7A and 10A, floating three-phase inverter 60 can be connected to a three-phase grid-connected induction machine connected in an open winding configuration as shown in FIG. 10A such that the power factor of the induction machine can be controlled by floating three-phase inverter 60.

Referring to FIGS. 7A and 10B, floating H-bridges 20 can be connected to a three-phase grid-connected induction machine connected in an open winding configuration as shown in FIG. 10B such that the power factor of the induction machine can be controlled by floating H-bridges 20.

Referring to FIGS. 7A and 10C, floating H-bridges 20 can be connected to a three-phase grid-connected induction machine connected in an open winding configuration as shown in FIG. 10C such that the power factor of the induction machine can be controlled by floating H-bridges 20.

Referring to FIGS. 7B and 11A, floating H-bridges 20 can be connected to a three-phase grid-connected induction machine connected in a wye configuration as shown in FIG. 11A such that the power factor of the induction machine can be controlled by floating H-bridges 20.

Referring to FIGS. 7B and 11 B, floating H-bridges 20 can be connected to a three-phase grid-connected induction machine connected in a wye configuration as shown in FIG. 11B such that the power factor of the induction machine can be controlled by floating H-bridges 20.

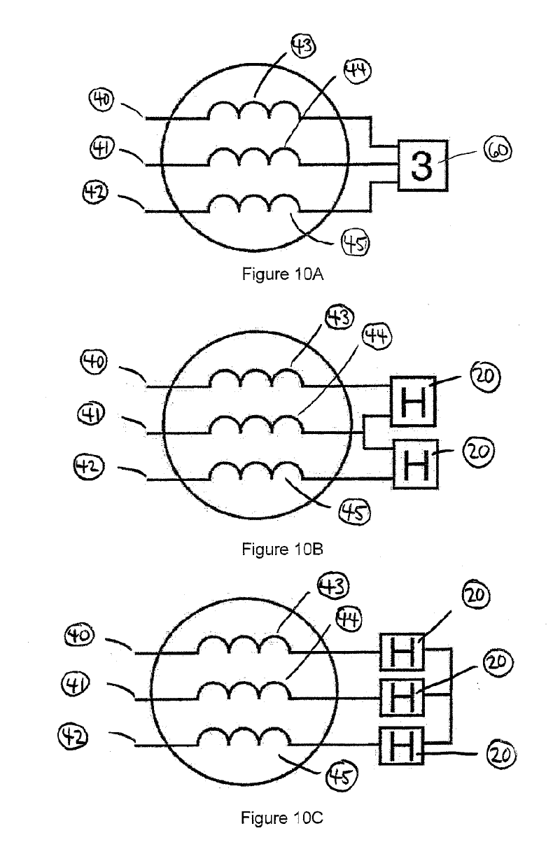

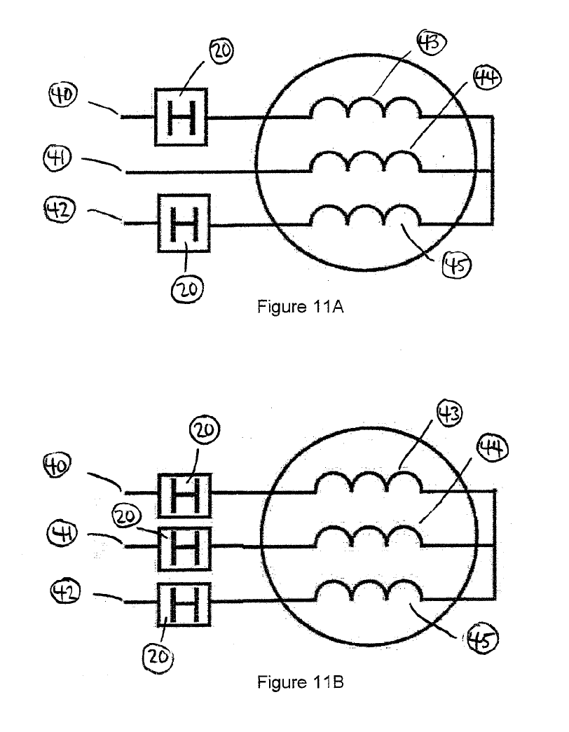

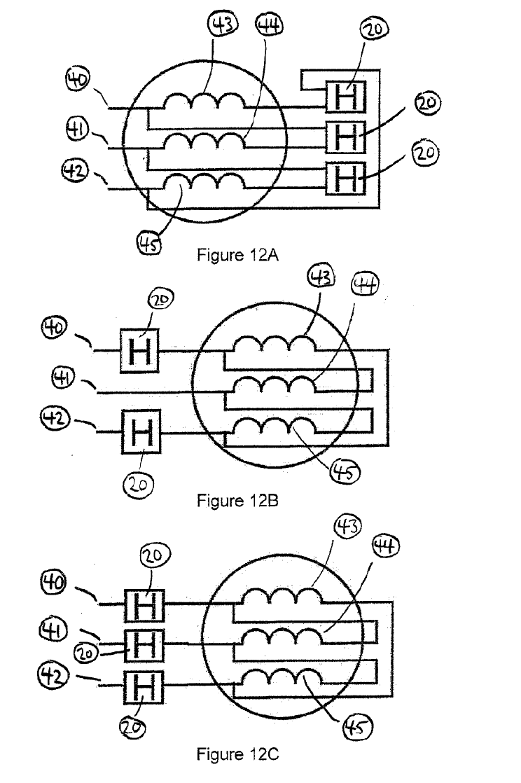

Referring to FIGS. 7C and 12A, floating H-bridges 20 can be connected to a three-phase grid-connected induction machine connected in a delta configuration as shown in FIG. 12A such that the power factor of the induction machine can be controlled by floating H-bridges 20.

Referring to FIGS. 7C and 12B, floating H-bridges 20 can be connected to a three-phase grid-connected induction machine connected in a delta configuration as shown in FIG. 12B such that the power factor of the induction machine can be controlled by floating H-bridges 20.

Referring to FIGS. 7C and 12C, floating H-bridges 20 can be connected to a three-phase grid-connected induction machine connected in a delta configuration as shown in FIG. 12C such that the power factor of the induction machine can be controlled by floating H-bridges 20.

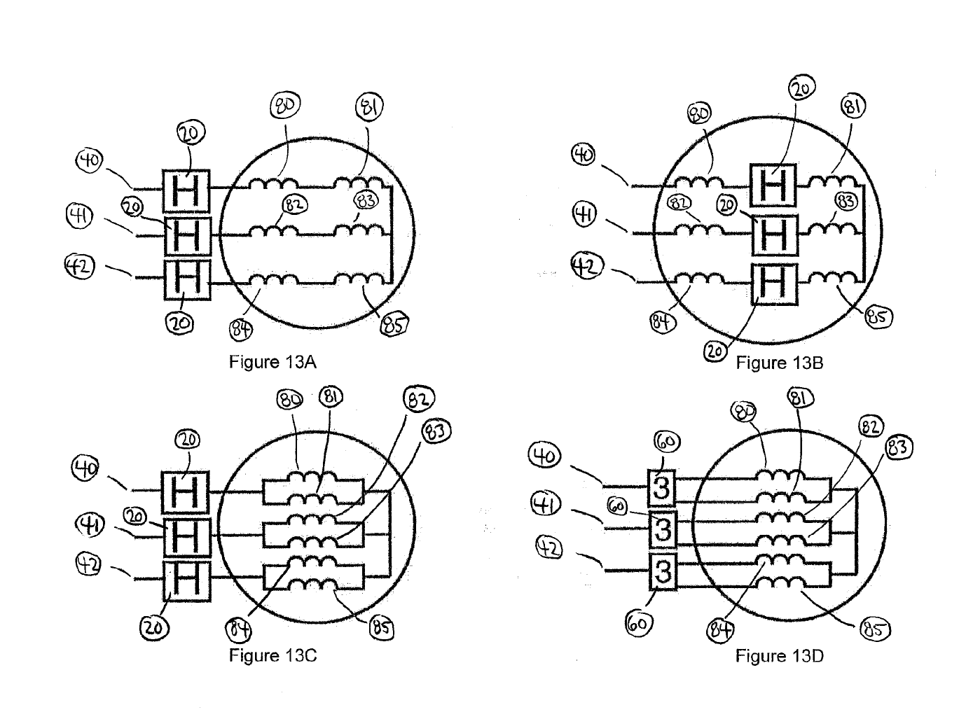

Referring to FIGS. 8A, 8B, 13A and 13B, floating H-bridges 20 can be connected to a nine-terminal three-phase grid-connected induction machine connected in a wye configuration with the windings connected to operate at a high voltage as shown in FIGS. 13A and 13B such that the power factor of the induction machine can be controlled by floating H-bridges 20.

Referring to FIGS. 8C and 13C, floating H-bridges 20 can be connected to a nine-terminal three-phase grid-connected induction machine connected in a wye configuration with the windings connected to operate at a low voltage as shown in FIG. 13C such that the power factor of the induction machine can be controlled by floating H-bridges 20.

Referring to FIGS. 8C and 13D, floating three-phase inverters 60 can be connected to a nine-terminal three-phase grid-connected induction machine connected in a wye configuration with the windings connected to operate at a low voltage as shown in FIG. 13D such that the power factor of the induction machine can be controlled by floating three-phase inverters 60.

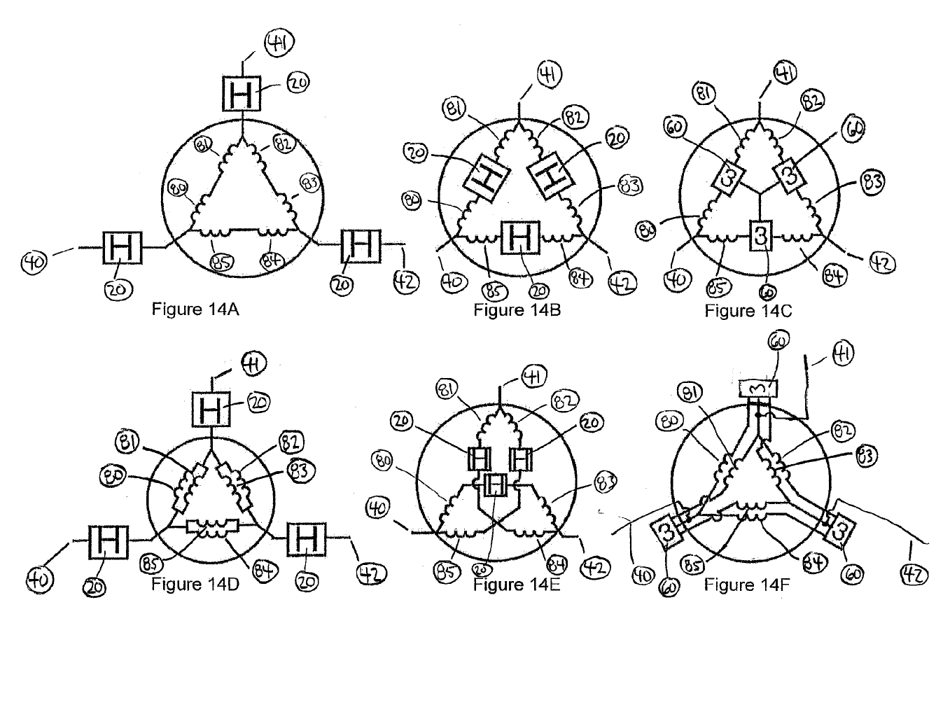

Referring to FIGS. 9A, 9B, 14A and 14B, floating H-bridges 20 can be connected to a nine-terminal three-phase grid-connected induction machine connected in a delta configuration with the windings connected to operate at a high voltage as shown in FIGS. 14A and 14B such that the power factor of the induction machine can be controlled by floating H-bridges 20.

Referring to FIGS. 9A, 9B and 14C, floating three-phase inverters 60 can be connected to a nine-terminal three-phase grid-connected induction machine connected in a delta configuration with the windings connected to operate at a high voltage as shown in FIG. 14C such that the power factor of the induction machine can be controlled by floating three-phase inverters 60.

Referring to FIGS. 9C, 14D and 14E, floating H-bridges 20 can be connected to a nine-terminal three-phase grid-connected induction machine connected in a delta configuration with the windings connected to operate at a low voltage as shown in FIGS. 14D and 14E such that the power factor of the induction machine can be controlled by floating H-bridges 20.

Referring to FIGS. 9C and 14F, floating three-phase inverters 60 can be connected to a nine-terminal three-phase grid-connected induction machine connected in a delta configuration with the windings connected to operate at a low voltage as shown in FIG. 14F such that the power factor of the induction machine can be controlled by floating three-phase inverters 60.

Additional details on the embodiments described above are provided in the attached Appendices “A” and “B”. The references listed in each of the attached Appendices A and B are hereby incorporated into this application by reference in their entirety.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method for controlling the power factor of an induction machine connected to a power distribution grid, the grid comprising an alternating voltage supply and at least one distribution line, and the induction machine comprising at least one winding, the method comprising the steps of:
a) connecting the at least one winding to the at least one distribution line such that the alternating voltage supply can deliver current to the at least one winding;
b) connecting an adjustable voltage source in series with the at least one winding, the adjustable voltage source configured to produce an output voltage whose magnitude and phase angle can be adjusted; and
c) adjusting the magnitude and phase angle of the output voltage until the desired power factor is achieved.

2. The method as set forth in claim 1 wherein the adjustable voltage source comprises an alternating current to direct current power electronic converter and a direct current energy storage device.

3. The method as set forth in claim 2 wherein the alternating current to direct current power electronic converter comprises a floating H-bridge.

4. The method as set forth in any one of claims 2 to 3 wherein the direct current energy storage device comprises a capacitor, a super capacitor or an electro-chemical battery.

5. The method as set forth in any one of claims 1 to 4 wherein the induction machine comprises an induction motor.

6. The method as set forth in any one of claims 1 to 4 wherein the induction machine comprises an induction generator.

7. A method for controlling the power factor of a polyphase induction machine connected to a polyphase power distribution grid, the grid comprising a plurality of grid phases, each grid phase further comprising an alternating voltage supply and at least one distribution line, and the induction machine comprising a plurality of induction machine phases, each induction machine phase further comprising at least one winding, the method comprising the steps of:
a) connecting the at least one winding of a first induction machine phase to the at least one distribution line of a first grid phase such that the alternating voltage supply of the first grid phase can deliver current to the at least one winding of the first induction machine phase;
b) connecting the at least one winding of the first induction machine phase to one or more other at least one windings of one or more other induction machine phases as required to achieve the desired connection configuration between the polyphase power distribution grid and the polyphase induction machine;
c) connecting an adjustable voltage source in series with the at least one winding of the first induction machine phase, the adjustable voltage source configured to produce an output voltage whose magnitude and phase angle can be adjusted; and
d) adjusting the magnitude and phase angle of the output voltage until the desired power factor is achieved.

8. The method as set forth in claim 7 wherein the adjustable voltage source comprises an alternating current to direct current power electronic converter and a direct current energy storage device.

9. The method as set forth in claim 8 wherein the alternating current to direct current power electronic converter comprises a floating H-bridge.

10. The method as set forth in claim 7 wherein the polyphase power distribution grid comprises a three-phase power distribution grid and the induction machine comprises a three-phase induction machine.

11. The method as set forth in claim 10 wherein the desired connection configuration between the three-phase power distribution grid and the three-phase induction machine comprises one or both of a wye configuration and a delta configuration.

12. The method as set forth in any one of claims 10 to 11 wherein the adjustable voltage source comprises a three-phase adjustable voltage source configured to produce three output voltages whose magnitudes and phase angles can be adjusted, and the three-phase adjustable voltage source is connected in series with two or more at least one windings of one or more induction machine phases.

13. The method as set forth in claim 12 wherein the three-phase adjustable voltage source comprises an alternating current to direct current power electronic converter and a direct current energy storage device.

14. The method as set forth in claim 13 wherein the alternating current to direct current power electronic converter comprises a floating three-phase inverter.

15. The method as set forth in any one of claims 8, 9, 13 and 14 wherein the direct current energy storage device comprises a capacitor, a super capacitor or an electro-chemical battery.

16. The method as set forth in any one of claims 7 to 15 wherein the induction machine comprises an induction motor.

17. The method as set forth in any one of claims 7 to 15 wherein the induction machine comprises an induction generator.

18. An improved induction machine with a controllable power factor, the improved induction machine comprising:
a) at least one induction machine phase, each induction machine phase further comprising at least one winding;
b) means for connecting the at least one winding of each induction machine phase to an external alternating voltage supply such that current can be supplied to the at least one winding of each at least one induction machine phase;
c) at least one adjustable voltage source configured to produce at least one output voltage whose magnitude and phase angle can be adjusted; and
d) means for connecting the at least one adjustable voltage source in series with the at least one winding of the at least one induction machine phase, wherein adjusting the magnitude and phase angle of the at least one output voltage changes the power factor.

19. The improved induction machine as set forth in claim 18, further comprising means for connecting the at least one winding of each at least one induction machine phase to one or more other at least one windings of one or more other induction machine phases as required to achieve the desired connection configuration between the induction machine phases.

20. The improved induction machine as set forth in any one of claims 18 to 19 wherein the adjustable voltage source comprises an alternating current to direct current power electronic converter and a direct current energy storage device.

21. The improved induction machine as set forth in claim 20 wherein the alternating current to direct current power electronic converter comprises a floating H-bridge.

22. The improved induction machine as set forth in claim 18 wherein the number of induction machine phases is three.

23. The improved induction machine as set forth in claim 22 wherein the desired connection configuration between the induction machine phases is a wye or delta configuration.

24. The improved induction machine as set forth in any one of claims 22 to 23 wherein the adjustable voltage source comprises a three-phase adjustable voltage source disposed to produce three output voltages whose magnitudes and phase angles can be adjusted, and the three-phase adjustable voltage source is connected in series with two or more at least one windings of one or more induction machine phases.

25. The improved induction machine as set forth in claim 24 wherein the three-phase adjustable voltage source comprises an alternating current to direct current power electronic converter and a direct current energy storage device.

26. The improved induction machine as set forth in claim 25 wherein the alternating current to direct current power electronic converter comprises a floating three-phase inverter.

27. The improved induction machine as set forth in any one of claims 19, 21, 25 and 26 wherein the direct current energy storage device comprises a capacitor, a super capacitor or an electro-chemical battery.

28. The improved induction machine as set forth in any one of claims 18 to 27 wherein the improved induction machine comprises an induction motor.

29. The improved induction machine as set forth in any one of claims 18 to 27 wherein the improved induction machine comprises an induction generator.

30. An induction machine with a controllable power factor, the induction machine comprising:
a) a first induction machine phase, the first induction machine phase further comprising a first winding; wherein the first winding of the first induction machine phase is connected to an external alternating voltage supply such that current can be supplied to the first winding of the first induction machine phase;
b) an adjustable voltage source configured to produce an output voltage whose magnitude and phase angle can be adjusted; and
c) wherein the adjustable voltage source is connected in series with the first winding of the first induction machine phase, and wherein adjusting the magnitude and phase angle of the output voltage changes the power factor.

31. The induction machine of claim 30, further comprising a second induction phase having a second winding, the winding of the first induction phase connected to the second winding.

32. The induction machine of one of claim 30 or 31 wherein the adjustable voltage source comprises an alternating current to direct current power electronic converter and a direct current energy storage device.

33. The induction machine of claim 32 wherein the alternating current to direct current power electronic converter comprises a floating H-bridge.

34. The induction machine of claim 30 further comprising second and third induction machine phases, having respective second and third windings.

35. The induction machine of claim 31 wherein the connection between the first and second winding is a wye or delta configuration.

36. The induction machine of claim 34 wherein the adjustable voltage source comprises a three-phase adjustable voltage source disposed to produce three output voltages whose magnitudes and phase angles can be adjusted, and the three-phase adjustable voltage source is connected in series with two or more of the first, second or third windings.

37. The improved induction machine as set forth in claim 36 wherein the three-phase adjustable voltage source comprises an alternating current to direct current power electronic converter and a direct current energy storage device.

38. The improved induction machine as set forth in claim 37 wherein the alternating current to direct current power electronic converter comprises a floating three-phase inverter.

39. The induction machine of one of claim 32 or 33 wherein the direct current energy storage device comprises a capacitor, a super capacitor or an electro-chemical battery.

40. The induction machine of one of claims 30 to 39 wherein the induction machine comprises an induction motor.

41. The induction machine of one of claims 30 to 39 wherein the induction machine comprises an induction generator.
